(19) United States
(12) Patent Application Publication
(10) Pub. No.: US 2021/0303972 A1
(43) Pub. Date: Sep. 30, 2021

(54) METHOD AND APPARATUS WITH NEURAL NETWORK QUANTIZATION

(71) Applicant: Samsung Electronics Co., Ltd., Suwon-si (KR)

(72) Inventors: Donghyun LEE, Seongnam-si (KR); Sangwon HA, Seongnam-si (KR)

(73) Assignee: Samsung Electronics Co., Ltd., Suwon-si (KR)

(21) Appl. No.: 17/012,181

(22) Filed: Sep. 4, 2020

(30) Foreign Application Priority Data
Mar. 31, 2020 (KR) 10-2020-0039428

(51) Int. Cl. G06N 3/04; G06N 3/08

(52) U.S. Cl. CPC G06N 3/0454; G06N 3/084; G06N 3/0472

(57) ABSTRACT

A method for neural network quantization includes performing a forward pass and a backward pass of a first neural network having a first bit precision with respect to each of a plurality of input data sets, obtaining profile information with respect to at least one of input gradients, weight gradients, and output gradients calculated for each layer of layers included in the first neural network in the process of performing the backward pass, determining one or more layers, from among the layers, to be quantized with a second bit precision less than the first bit precision, based on the obtained profile information, and generating a second neural network by quantizing the determined layers from among the layers with the second bit precision.

### CROSS-REFERENCE TO RELATED APPLICATION

This application claims the benefit under 35 USC 119(a) of Korean Patent Application No. 10-2020-0039428, filed on Mar. 31, 2020, in the Korean Intellectual Property Office, the entire disclosure of which is incorporated herein by reference for all purposes.

### BACKGROUND

### 1. Field

The present disclosure relates to methods and apparatuses for neural network quantization.

### 2. Description of Related Art

With the development of neural network technology, various kinds of electronic systems have been actively studied for analyzing input data and extracting valid information using a neural network device.

Neural network devices require a large amount of computation for complex input data. In order for the neural network devices to analyze the input data in real-time and extract information, a technique capable of efficiently performing a neural network operation may be desired. For example, since low-powered high-performance embedded systems, such as smartphones, have limited resources, a technique capable of minimizing accuracy loss required to process complex input data while reducing the amount of computation may be needed.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a method for neural network quantization includes performing a forward pass and a backward pass of a first neural network having a first bit precision with respect to each of a plurality of input data sets, obtaining profile information with respect to at least one of input gradients, weight gradients, and output gradients calculated for each layer of layers included in the first neural network in the process of performing the backward pass, determining one or more layers, from among the layers, to be quantized with a second bit precision less than the first bit precision, based on the obtained profile information, and generating a second neural network by quantizing the determined layers from among the layers with the second bit precision.

The profile information may include a normalized statistic obtained by dividing an average of absolute values of the weight gradients by an average of absolute values of weights.

The profile information may include a normalized statistic obtained based on values of the weight gradients and weight values.

The profile information may include a statistic obtained by dividing a variance of absolute values of the input gradients by an average of the absolute values of the input gradients.

The profile information may include a normalized statistic obtained based on variance values of the input gradients and the input gradient values.

The profile information may include a normalized statistic obtained by dividing a variance of absolute values of weights for each of the layers by a number of parameters for each channel.

The profile information may include a normalized statistic obtained based on values of weights and a number of parameters for each of the layers.

The method may further include sorting the layers in an order of statistical size corresponding to the obtained profile information. The determining of the layers may include determining layers having a relatively small statistical size as one or more layers to be quantized from among the sorted layers.

The determining of the layers may include determining one or more layers to be quantized by searching whether an accuracy loss of the second neural network is within a predetermined threshold value compared with the first neural network when some of the sorted layers are quantized with the second bit precision.

The first neural network may correspond to a neural network quantized from a third neural network having layers of floating-point parameters of a third bit precision that is greater than the first bit precision and having layers of fixed-point parameters of the first bit precision. The second neural network may correspond to a neural network quantized such that the determined layers from among the layers have fixed-point parameters with the second bit precision and the remaining layers have fixed-point parameters with the first bit precision.

The method may generate the second neural network by performing quantization for each channel of the determined layers of the first neural network based on the obtained profile information without retraining the second neural network.

The method may further include performing a convolution operation between a quantized input feature map and a weight map based on a scale factor determined for each channel in an inference process using the generated second neural network, reflecting the scale factor of the input feature map on the results of the convolution operation before calculating the partial sum for each channel of a output feature map, and obtaining the output feature map by accumulating the results of the convolution operation on which the scale factor of the input feature map is reflected for each channel.

The method may further include quantizing the output feature map based on the scale factor of the weight map without determining a separate scale factor for the output feature map.

In another general aspect, a neural network quantization apparatus includes a memory storing at least one program and a processor. The processor is configured to perform neural network quantization by executing the at least one program. The processor is further configured to perform, with respect to each of a plurality of input data sets, a forward pass and a backward pass of a first neural network having a first bit precision, obtain profile information for at least one of input gradients, weight gradients, and output gradients calculated for each layer of layers included in the first neural network in the process of performing the backward pass, determine one or more layers to be quantized with a second bit precision less than the first bit precision, among the layers, based on the obtained profile information, and generate a second neural network by quantizing the determined layers from among the layers with the second bit precision.

The profile information may include a normalized statistic by dividing an average of absolute values of the weight gradients by an average of absolute values of weights.

The profile information may include a statistic obtained by dividing a variance of absolute values of the input gradients by an average of the absolute values of the input gradients.

The profile information may include a normalized statistic obtained by dividing a variance of absolute values of weights for each layer of the layers by a number of parameters for each channel.

The processor may be further configured to sort the layers in an order of statistical size corresponding to the obtained profile information, and determine layers having a relatively small statistical size as one or more layers to be quantized, from among the sorted layers.

The processor may be further configured to determine one or more layers to be quantized by searching whether an accuracy loss of the second neural network is within a predetermined threshold value compared with the first neural network when some of the sorted layers are quantized with the second bit precision.

The first neural network may correspond to a neural network quantized from a third neural network having layers of floating-point parameters of a third bit precision that is greater than the first bit precision and having layers of fixed-point parameters of the first bit precision. The second neural network may correspond to a neural network quantized such that the determined layers from among the layers have fixed-point parameters with the second bit precision and the remaining layers have fixed-point parameters with the first bit precision.

The processor may be further configured to generate the second neural network is by performing quantization for each channel of the determined layers of the first neural network based on the obtained profile information without retraining the second neural network.

The processor may be further configured to perform a convolution operation between a quantized input feature map and a weight map based on a scale factor determined for each channel in an inference process using the generated second neural network, reflect the scale factor of the input feature map to the results of the convolution operation before calculating the partial sum for each channel of a output feature map, and obtain the output feature map by accumulating the results of the convolution operation on which the scale factor of the input feature map is reflected for each channel.

The processor may be further configured to quantize the output feature map based on the scale factor of the weight map without determining a separate scale factor for the output feature map.

A configuration of an electronic system may be controlled or determined based on the neural network quantization apparatus.

Other features and aspects will be apparent from the following detailed description, the drawings, and the claims.

### BRIEF DESCRIPTION OF THE DRAWINGS

FIG. 1 is a diagram illustrating an architecture of a neural network, according to an embodiment.

FIG. 2 is a diagram for explaining an operation performed in a neural network, according to an embodiment.

FIG. 3 is a diagram for explaining a forward pass and a backward pass of a neural network, according to an embodiment.

FIG. 4 is a block diagram showing a hardware configuration of a neural network quantization apparatus, according to an embodiment.

FIG. 5 is a diagram for explaining the use of a neural network in a hardware accelerator after quantizing a pre-trained neural network, according to an embodiment.

FIG. 6 is a flowchart of a method of quantizing a neural network, according to an embodiment.

FIG. 7 is a flowchart of a method of determining layers to be quantized according to an embodiment.

FIG. 8 is a schematic diagram illustrating a process of quantizing a neural network, according to an embodiment.

FIG. 9 is a diagram for explaining a scale factor used for quantizing a neural network, according to an embodiment.

FIG. 10 is a diagram showing an algorithm for performing inference using a typical quantized neural network.

FIG. 11 is a diagram illustrating an algorithm for performing inference using a quantized neural network, according to an embodiment.

FIG. 12 is a block diagram illustrating a configuration of an electronic system, according to an embodiment.

Other features and aspects will be apparent from the following detailed description, the drawings, and the claims.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known after understanding of the disclosure of this application may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

Throughout the specification, when an element, such as a layer, region, or substrate, is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

As used herein, the term “and/or” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Spatially relative terms such as “above,” “upper,” “below,” and “lower” may be used herein for ease of description to describe one element's relationship to another element as shown in the figures. Such spatially relative terms are intended to encompass different orientations of the device in use or operation in addition to the orientation depicted in the figures. For example, if the device in the figures is turned over, an element described as being “above” or “upper” relative to another element will then be “below” or “lower” relative to the other element. Thus, the term “above” encompasses both the above and below orientations depending on the spatial orientation of the device. The device may also be oriented in other ways (for example, rotated 90 degrees or at other orientations), and the spatially relative terms used herein are to be interpreted accordingly.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

The features of the examples described herein may be combined in various ways as will be apparent after an understanding of the disclosure of this application. Further, although the examples described herein have a variety of configurations, other configurations are possible as will be apparent after an understanding of the disclosure of this application.

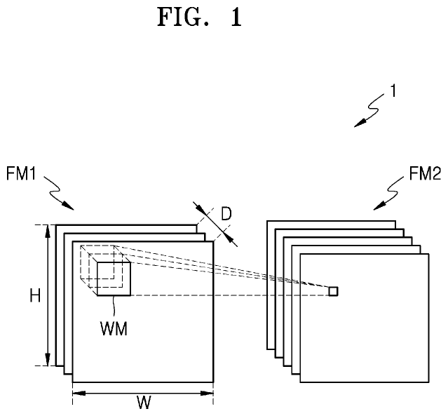

FIG. 1 is a diagram illustrating an architecture of a neural network 1, according to an embodiment.

Referring to FIG. 1, a neural network 1 may be represented by a mathematical model using nodes and edges. The neural network 1 may include the architecture of a deep neural network (DNN) or n-layers neural networks. The DNN or n-layers neural networks may correspond to convolutional neural networks (CNNs), recurrent neural networks (RNNs), deep belief networks, restricted Boltzman machines, etc. For example, the neural network 1 may be implemented as a CNN, but is not limited thereto. The neural network 1 of FIG. 1 may correspond to some layers of the CNN. Accordingly, the neural network 1 may correspond to a convolutional layer, a pooling layer, or a fully connected layer, etc. of a CNN. However, for convenience, in the following descriptions, it is assumed that the neural network 1 corresponds to the convolutional layer of the CNN.

In the convolution layer of FIG. 1, in an example, a first feature map FM1 may correspond to an input feature map, and a second feature map FM2 may correspond to an output feature map. The feature map may denote a data set representing various characteristics of input data. The first and second feature maps FM1 and FM2 may be a high-dimensional matrix of two or more dimensions, and have respective activation parameters. When the first and second feature maps FM1 and FM2 correspond to, for example, three-dimensional feature maps, the first and second feature maps FM1, and FM2 have a width W (or column), a height H (or row), and a depth D. At this point, the depth D may correspond to the number of channels.

In the convolution layer of FIG. 1, in an example, a convolution operation with respect to the first feature map FM1 and a weight map WM may be performed. As a result, the second feature map FM2 may be generated. The weight map WM may filter the first feature map FM1 and is referred to as a filter or kernel. In one example, a depth of the weight map WM, that is, the number of channels is the same as the depth D of the first feature map FM1, that is, the number of channels. The weight map WM is shifted by traversing the first feature map FM1 as a sliding window. In each shift, weights included in the weight map WM may respectively be multiplied and added to all feature values in a region overlapping with the first feature map FM1. As the first feature map FM1 and the weight map WM are convolved, one channel of the second feature map FM2 may be generated. In FIG. 1, although one weight map WM is depicted, substantially, a plurality of channels of the second feature map FM2 may be generated by convolving the plurality of weight maps with the first feature map FM1.

The second feature map FM2 of the convolution layer may be an input feature map of the next layer. For example, the second feature map FM2 may be an input feature map of a pooling layer.

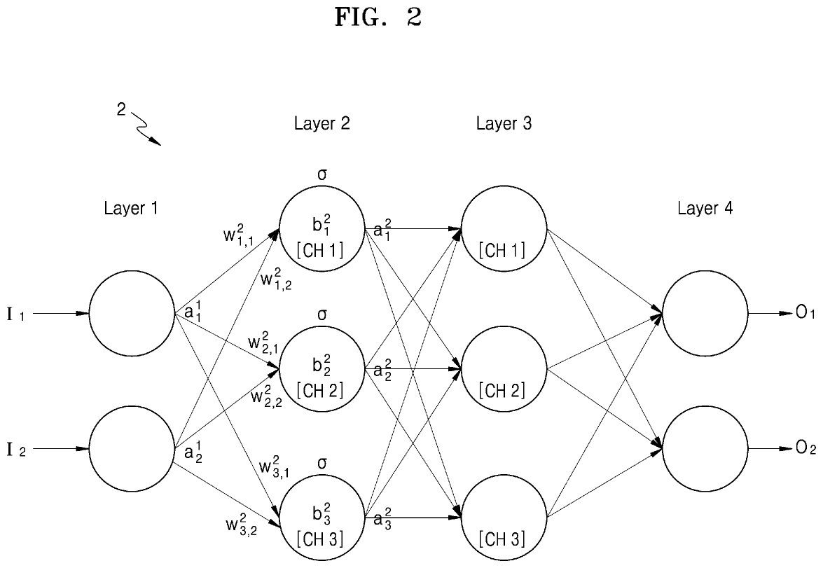

FIG. 2 is a diagram for explaining an operation performed in a neural network 2, according to an embodiment.

In the example of FIG. 2, the neural network 2 has a structure including input layers, hidden layers, and output layers, and performs operations based on received input data (for example, I₁ and I₂), and may generate output data (for example, O₁ and O₂) based on a result of the operations.

As described above, the neural network 2 may be a DNN or an n-layer neural network, including two or more hidden layers. For example, as illustrated in FIG. 2, the neural network 2 may be a DNN, including an input layer (Layer 1), two hidden layers (Layer 2 and Layer 3), and an output layer (Layer 4). When the neural network 2 is implemented as a DNN architecture, the neural network 2 further includes a large number of layers capable of processing valid information, and thus, the neural network 2 may process a large number of complex data sets than a neural network having a single layer. However, although the neural network 2 is illustrated as including four layers, this is only an example, and the neural network 2 may include a smaller or larger number of layers and/or channels. That is, the neural network 2 may include layers of various structures different from those illustrated in FIG. 2.

Each of the layers included in the neural network 2 may include a plurality of channels. A channel may correspond to a plurality of artificial nodes, processing elements (PEs), units, or similar terms. For example, as illustrated in FIG. 2, Layer 1 may include two channels (nodes), and each of the Layer 2 and Layer 3 may include three channels. However, this is only an example, and each of the layers included in the neural network 2 may include various numbers of channels (nodes).

The channels included in each of the layers of the neural network 2 may be connected to each other to process data. For example, one channel may receive data from other channels for operation and output the operation result to other channels.

Each of the inputs and outputs of each of the channels may be referred to as an input activation and an output activation, respectively. That is, the activation may be an output of one channel and may be a parameter corresponding to an input of channels included in the next layer.

Each of the channels may determine its activation based on activations and weights received from channels included in the previous layer. The weight is a parameter used to operate an output activation in each channel, and may be a value assigned to a connection relationship between channels.

Each of the channels may be processed by a computational unit or a processing element that outputs an output activation by receiving an input, and an input-output of each of the channels may be mapped. For example, when 6 is an activation function, wⱼₖⁱ is a weight from a k^{th} channel included in an (i−1)^{th} layer to a j^{th} channel included in an layer, bⱼⁱ is a bias of the j^{th} channel included in the layer, and aⱼⁱ is an activation of the j^{th} channel in the i^{th} layer, the activation may be calculated by using Equation 1 below.

$${a}_{j}^{i} = σ ( {\sum }_{k} ( {w}_{jk}^{i} \times {a}_{k}^{i - 1} ) + {b}_{j}^{i} ) : \qquad Equation 1$$

As shown in FIG. 2, the activation of a first channel CH1 of the second layer Layer 2 may be expressed as a a₁². Also, a₁² may have a value of a₁²=σ(w_{1,1}²×a₁¹+w_{1,2}²+a₂¹+b₁²) according to the Equation 1. However, Equation 1 described above is only an example for describing activations and weights used to process data in the neural network 2, but is not limited thereto. Activation may be a value obtained by passing a value in which an activation function is applied to a sum of activations received from a previous layer through a Rectified Linear Unit (ReLU).

As described above, in the neural network 2, a large number of data sets are exchanged between a plurality of interconnected channels, and a number of computational processes are performed through layers. Therefore, a technique capable of minimizing accuracy loss while reducing the amount of computation required to process complex input data is needed.

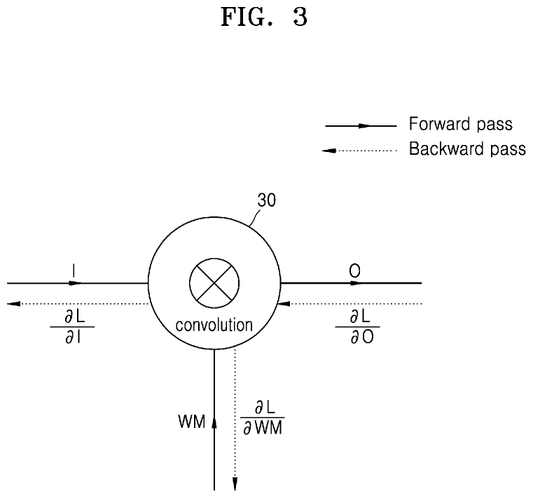

FIG. 3 is a diagram for explaining a forward pass and a backward pass of a neural network, according to an embodiment.

The forward pass may correspond to a process in which, after input data is input to an input layer of the neural network, an operation is performed while the input data is sequentially passing through several layers, such as an input layer, hidden layers, and an output layer, and output data is finally output from the output layer.

For example, as illustrated in FIG. 3, as the forward pass of the neural network is performed, an input feature map I may be input to a layer 30, which is one of the layers included in the neural network. A convolution operation between the weight map WM matched to the layer 30 and the input feature map I may be performed. An output feature map O outputted as a result of the convolution operation may be used as an input feature map of the next layer. The convolution operation performed in the layer 30 may correspond to the operation described above with reference to FIG. 2. As the forward pass of the neural network is performed, output data is output from the output layer, and a process of performing recognition based on the output data may correspond to the inference of the neural network.

After the forward pass of the neural network is performed, the backward pass of the neural network may be performed. The backward pass of the neural network may denote a process in which a loss L, determined according to a difference between output data output from an output layer as a result of the forward pass of the neural network and an actual target data (for example, ground truth), is transmitted in reverse order to the forward pass (that is, in the order from the output layer, hidden layers, and the input layer). The loss L may be determined by a loss function. The loss function may be an L1 loss function that outputs a loss based on an absolute value of a difference between the output data and the actual target data, or an L2 loss function that outputs a loss based on the square of the absolute value of the difference between the output data and the actual target data, but is not limited thereto.

As the loss L is transmitted to layers through the backward pass, a parameter affecting the loss L in each of the layers may be calculated. For example, as the backward pass of the neural network is performed, an output gradient,

$$\frac{\partial L}{\partial O}$$

which is a parameter indicating the effect of the output feature map O of the layer 30 on the loss L, may be delivered from a next layer to the layer 30. When the output gradient

$$\frac{\partial L}{\partial O}$$

is transmitted to the layer 30, a weight gradient

$$\frac{δ L}{δ WM}$$

that is a parameter indicating the effect of the weight map WM on the loss L may be calculated based on a convolution operation between the input feature map I and the output gradient

$$\frac{δ L}{δ O} .$$

The weight map WM matched to the layer 30 may be updated according to the following Equation 2 based on the calculated weight gradient

$$\frac{δ L}{δ WM} .$$

$${WM}_{updated} = WM - α \frac{\partial L}{\partial WM} : \qquad Equation 2$$

In Equation 2, a may correspond to a learning rate and may be a parameter tuned by an optimization algorithm that determines a step size in each iteration, moving toward a minimum point of the loss function.

As described above, when the backward pass of the neural network is performed, the neural network may be updated so that a loss L is reduced as weight maps matched to layers included in the neural network are updated. The update process corresponds to a backpropagation of the neural network, and the neural network may be trained or learned through the backpropagation.

An input gradient,

$$\frac{δ L}{δ I} ,$$

which is a parameter indicating the effect of the input feature map I on the loss L, may be calculated based on a convolution operation between a matrix that is partially modified by the weight map WM and the output gradient

$$\frac{δ L}{δ O} .$$

wince me input feature map I of the layer 30 corresponds to the output feature map O of the previous layer, the calculated input gradient

$$\frac{δ L}{δ I}$$

may be transferred to the previous layer and used as an output gradient of the previous layer.

In FIG. 3, for convenience of explanation, the previous layer and the next layer of the layer 30 are referred based on the forward pass, but the previous layer and the next layer of the layer 30 may also be referred based on the backward pass, and in this case, those skilled in the art and after a reading of this disclosure may readily understand that the case may be opposite to the case of the forward pass. Also, the specific process of calculating the input gradient, the weight gradient, and the output gradient defined above is obvious to those skilled in the art, and thus, the description thereof will be omitted.

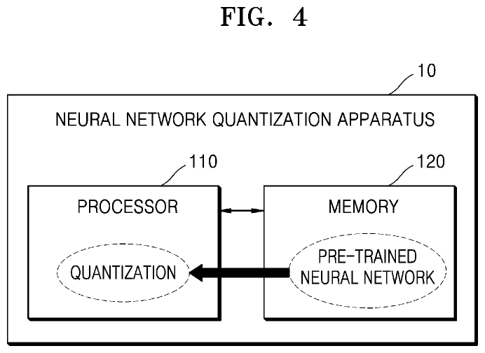

FIG. 4 is a block diagram showing a hardware configuration of a neural network quantization apparatus 10, according to an embodiment.

Referring to FIG. 4, the neural network quantization apparatus 10 may include a processor 110 and a memory 120. In the neural network quantization apparatus 10, illustrated in FIG. 4, only components related to the present embodiments are illustrated. Accordingly, it is apparent to those skilled in the art that the neural network quantization apparatus 10 may further include other general-purpose components in addition to the components shown in FIG. 4.

The neural network quantization apparatus 10 may correspond to a computing device having various processing functions, such as generating a neural network, training (or learning) a neural network, quantizing a neural network having floating-point parameters into a neural network having fixed-point parameters, or retraining the neural network. For example, the neural network quantization apparatus 10 may be implemented as various types of devices, such as a personal computer (PC), a server device, and a mobile device, etc.

The processor 110 performs an overall function for controlling the neural network quantization apparatus 10. For example, the processor 110 controls an overall operation of the neural network quantization apparatus 10 by executing programs stored in the memory 120 in the neural network quantization apparatus 10. The processor 110 may be implemented as a central processing unit (CPU), a graphic processing unit (GPU), or an application processor (AP) provided in the neural network quantization apparatus 10, but is not limited thereto.

The memory 120 is hardware that stores various data processed in the neural network quantization apparatus 10. For example, the memory 120 may store data processed and data to be processed in the neural network quantization apparatus 10. Also, the memory 120 may store applications, drivers, and the like to be driven by the neural network quantization apparatus 10.

The memory 120 may be DRAM, but is not limited thereto. The memory 120 may include at least one of volatile memory and non-volatile memory. The non-volatile memory includes read only memory (ROM), programmable ROM (PROM), electrically programmable ROM (EPROM), electrically erasable and programmable ROM (EEPROM), flash memory, phase-change RAM (PRAM), magnetic RAM (MRAM), resistive RAM (RRAM), ferroelectric RAM (FRAM), etc. The volatile memory includes dynamic RAM (DRAM), static RAM (SRAM), synchronous DRAM (SDRAM), PRAM, MRAM, RRAM, FeRAM, etc. In an embodiment, the memory 120 may include at least one of hard disk drive (HDD), solid-state drive (SSD), compact flash (CF), secure digital (SD), micro secure digital (micro-SD), mini-SD (mini secure digital), xD (extreme digital), and Memory Stick.

The processor 110 may generate a pre-trained neural network and store it in the memory 120. However, the present inventive concept is not limited thereto, and the processor 110 may receive a pre-trained neural network generated by a separate external device other than the neural network quantization apparatus 10 and store it in the memory 120.

The pre-trained neural network may refer to a neural network generated by repeatedly training (or learning) a given initial neural network. At this point, the initial neural network may have floating-point parameters, for example, 32-bit floating-point precision parameters, in order to secure the processing accuracy of the neural network. Here, the parameters may include various types of data input/output to the neural network, such as input/output activations, weights, and biases of the neural network. As iterative training of the neural network progresses, the floating-point parameters of the neural network may be tuned or updated to compute a more accurate output for a given input.

However, floating-point parameters with high bit precision require a relatively large amount of computation and a high memory access frequency compared with fixed-point parameters with low bit precision. Also, most of the computational amount required for processing of a neural network is known as a convolution operation that performs the computation of various parameters. Therefore, in mobile devices, such as smartphones, tablets, wearable devices, etc., which have relatively low processing performance and embedded devices, the processing of a neural network having floating-point parameters with high bit precision may not be smooth. Eventually, in order to drive the neural network within an allowable accuracy loss while sufficiently reducing the amount of computation in such devices, it is desirable that the floating-point parameters with high bit precision processed in the neural network are quantized. Here, the parameter quantization denotes converting a floating-point parameter to a fixed-point parameter, or reducing the bit precision of the parameter.

The neural network quantization apparatus 10 may perform quantization on a neural network in which parameters of a trained neural network are converted to fixed-points with predetermined bit precision considering the processing performance of a device (for example, a mobile device, an embedded device, etc.) to which the neural network is deployed. The device to which the neural network will be deployed may be the neural network quantization apparatus 10 itself, or may be another device outside the neural network quantization apparatus 10. The neural network quantization apparatus 10 may deliver a quantized neural network to a device to which the neural network is deployed. Devices to which the neural network is deployed include, for example, autonomous vehicles, robotics, smartphones, tablet devices, augmented reality (AR) devices, and Internet of Things (loT) devices that perform voice recognition, video recognition, etc. using neural networks, etc., but are not limited thereto.

The processor 110 may obtain data of a pre-trained neural network by using floating-points stored in the memory 120. The pre-trained neural network may be data repeatedly trained floating-point parameters with high bit precision. The training of the neural network may be, but is not limited to, repeated training by using a training data set as an input, and then repeated training again by using a test data set. The training data set is input data for training the neural network, and the test data set is input data that do not overlap with the training data set, and is data for training the neural network while measuring the performance of the neural network trained with the training data set.

A method of quantizing each layer included in the neural network by the processor 110 to a fixed-point with low bit precision will be described in detail with reference to the corresponding drawings.

The memory 120 may store a data set, for example, initial neural network data that has not been trained, neural network data generated in a training process, neural network data on which all training is completed, and quantized neural network data related to a neural network to be processed or processed by the processor 110, and also store various programs related to a training algorithm, quantization algorithm, etc. of the neural network to be executed by the processor 110.

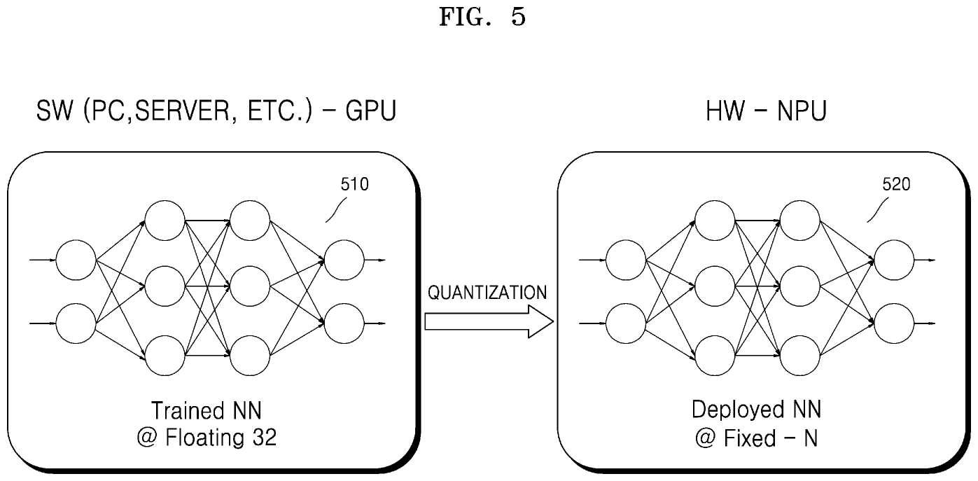

FIG. 5 is a diagram for explaining the employment of a neural network in a hardware accelerator after quantizing a pre-trained neural network, according to an embodiment.

Referring to FIG. 5, a processor of an external device, such as a PC, a server, etc. may train a neural network 510 of a floating-point (for example, 32-bit floating-point precision), and afterward, may transmit the trained neural network 510 to a neural network quantization apparatus (for example, the neural network quantization apparatus 10 of FIG. 4). However, the present inventive concept is not limited thereto, that is, the trained neural network 510 may be generated by a processor of a neural network quantization apparatus (for example, the processor 110 of FIG. 4).

Since the pre-trained neural network 510 itself may not be efficiently processed in a low power or low-performance hardware accelerator due to high bit precision floating-point parameters, a processor of the neural network quantization apparatus quantizes the neural network 510 having floating-point parameters to a neural network 520 having fixed-point (for example, fixed-point precision of 16 bits or less) parameters. The hardware accelerator is a dedicated hardware for driving the neural network 520, and may be implemented with relatively low power or low performance, and thus, may be more suitable for a fixed-point operation than a floating-point operation. The hardware accelerator may correspond to, for example, a neural processing unit (NPU), a sensor processing unit (TPU), and a neural engine, which are dedicated modules for driving a neural network, but are not limited thereto.

The hardware accelerator that drives the quantized neural network 520 may be implemented in the same apparatus as the neural network quantization apparatus. However, the present inventive concept is not limited thereto, and the hardware accelerator may be implemented as a separate device from the neural network quantization apparatus.

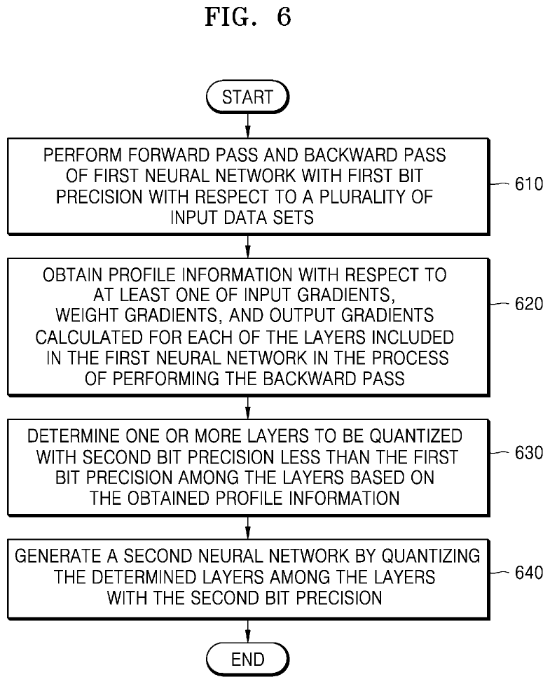

FIG. 6 is a flowchart of a method of quantizing a neural network, according to an embodiment. The method of FIG. 6 may be performed by a processor (for example, the processor 110 of FIG. 4) of a neural network quantization apparatus (for example, the neural network quantization apparatus 10 of FIG. 4).

In operation 610, the processor may perform, with respect to each of plurality of input data sets, a forward pass and a backward pass of a first neural network having a first bit precision. For example, the processor may perform a forward pass and a backward pass of a first neural network by inputting a first input data set from among a plurality of data sets into the first neural network, and perform a forward pass and a backward pass of the first neural network by inputting a second input data set into the first neural network. Also, the processor may perform forward and backward passes of the first neural network for remaining input data sets. Since the forward pass and the backward pass have been described with reference to FIG. 3, and thus, descriptions already given with reference to FIG. 3 will be omitted.

In operation 620, the processor may obtain profile information with respect to at least one of input gradients, weight gradients, and output gradients calculated for each of the layers included in the first neural network in the process of performing a backward pass. For example, the processor may separately obtain profile information corresponding to the first layer included in the first neural network and profile information corresponding to the second layer different from the first layer.

The profile information may correspond to a statistic having at least one of input gradients, weight gradients, and output gradients as a factor. The statistic corresponding to the profile information may be proportionally or inversely proportional to a loss determined according to a difference between output data output from an output layer and actual target data as a result of a forward pass of the neural network. Accordingly, when the statistic of each of the layers is compared and analyzed, among layers included in the first neural network, layers that are regarded as having relatively low importance (for example, layers having a relatively small effect on accuracy loss) may be determined.

In some embodiments, the profile information may include a normalized statistic by using values of weight gradients and values of weights. For example, the profile information may include the normalized statistic obtained by dividing an average of absolute values of weight gradients by an average of absolute values of weights. As described above with reference to FIG. 3, since weight gradients are parameters indicating an effect of a weight map (or weights included in the weight map) on a loss, the meaning that the weight gradients corresponding to a specific layer are small may denote that even if the value of the map (or weights included in the weight map) is slightly changed, the inferential ability of the first neural network is not significantly changed. In other words, when a layer having a relatively small value of weight gradients is quantized, the accuracy loss of the first neural network may be reduced than when a layer having a relatively large value of weight gradients is quantized.

However, since the effects of the number 0.1 on 1 and 0.2 are different from each other, it may be preferable to consider the absolute values of weights and weight gradients together rather than only weight gradients. Accordingly, as the profile information, a normalized statistic that is obtained by dividing an average of absolute values of weight gradients by an average of absolute values of weights may be used.

In one example, an average of absolute values of the weight gradients of the l^{th} layer obtained by performing forward and backward passes of the first neural network on an i^{th} input data set is expressed as |ΔWᵢ^{l}| and an average of absolute values of weights is expressed as |Wᵢ^{l}|, a statistic that uses the weight gradients corresponding to N input data sets as factors may be determined according to Equation 3 below.

$$\frac{1}{N} {\sum }_{i = 1}^{N} \frac{\vert Δ {W}_{i}^{ℓ} \vert}{\vert {W}_{i}^{ℓ} \vert} : \qquad Equation 3$$

Also, the profile information may include a normalized statistic by using a variance value of input gradients and a value of input gradients. For example, the profile information may further include a statistic obtained by dividing a variance of the absolute values of the input gradients by an average of absolute values of the input gradients. Since the weight gradient is calculated based on the input feature map and the output gradient, it may be interpreted that a change in the input feature map affects the weight. Accordingly, a change that occurs as the N sets of weight gradients calculated for each of the N input data sets are sequentially accumulated may be confirmed through an input gradient calculated based on a weight map and an output gradient. Accordingly, as the profile information, a statistic obtained by dividing a variance of absolute values of the input gradients by an average of absolute values of the input gradients may be additionally used.

In one example, when an average of absolute values of input gradients of the l^{th} layer obtained by performing forward pass and backward pass of the first neural network on iₜₕ input data set is expressed as

$$μ = \frac{1}{N} {\sum }_{i = 1}^{N} \vert Δ {I}_{i}^{ℓ} \vert$$

and a variance of the absolute values of the input gradients is expressed as

$$μ = \frac{1}{N} {\sum }_{i = 1}^{N} \vert Δ {I}_{i}^{ℓ} - μ \vert ,$$

the statistic using the input gradients as a factor may be determined according to Equation 4 below.

$$\frac{\frac{1}{N} {\sum }_{i = 1}^{N} \vert Δ {I}_{i}^{ℓ} - μ \vert}{\frac{1}{N} {\sum }_{i = 1}^{N} \vert Δ {I}_{i}^{ℓ} \vert} : \qquad Equation 4$$

Equation 4 may correspond to a coefficient of variance of input gradients.

Also, the profile information may include a statistic normalized by using values of weights and the number of parameters for each of the layers. For example, the profile information may further include a normalized statistic obtained by dividing the variance of absolute values of weights for each layer by the number of parameters for each channel. When quantization for each channel is performed, the greater the difference in the distribution of values of weights in each channel, the greater the quantization error according to lower bit quantization. Accordingly, in the quantization of a neural network, the variance of weights should also be considered in order to determine a layer having relatively low importance. Also, since the effect of the variance of weights on quantization on a neural network may vary depending on the number of parameters per channel, a normalized statistic obtained by dividing the variance of absolute values of weights by the number of parameters per channel may be used as the profile information.

According to some embodiments, when a statistic corresponding to the profile information has all of the input gradients, weight gradients, and output gradients as factors, the statistic may be simply expressed by Equation 5 below.

$$\frac{avg ( abs ( weight gradients ) )}{avg ( abs ( weights ) )} \times \frac{var ( abs ( input gradients ) )}{avg ( abs ( input gradients ) )} \times \frac{var ( abs ( weights ) )}{cnt ( parameter ) / cnt ( channel )} : \qquad Equation 5$$

In Equation 5, “avg” denotes mean, “abs” denotes absolute value, “var” denotes variance, and “cnt” denotes number (i.e., counted value).

On the other hand, in a quantization of an input feature map, when scale factors are differently set only for each layer, as the scale factors that exist as many as the number of channels of an original output feature map for an output feature map of a specific layer are expressed as one scale factor, the amount of information lost may increase. Accordingly, in this case, since a statistical amount (for example, a coefficient of variation) corresponding to a distribution difference of weight values for each channel should be additionally considered, the amount of statistic may be determined as Equation 6 below.

$$\frac{avg ( abs ( weight gradients ) )}{avg ( abs ( weights ) )} \times \frac{var ( abs ( input gradients ) )}{avg ( abs ( input gradients ) )} \times \frac{var ( abs ( weights ) )}{cnt ( parameter ) / cnt ( channel )} \times \frac{var ( avg\_of \_each \_ch ( abs ( weights ) ) )}{avg ( abs ( weights ) )} : \qquad Equation 6$$

When Equation 6 is compared to Equation 5, the last term (that is, a statistic corresponding to the distribution difference of weight values for each channel) is added to Equation 5. In Equation 6, “avg_of_each_ch” may denote an average for each channel.

On the other hand, in Equations 5 and 6, for convenience of explanation, a case when the statistic corresponding to the profile information has all of the input gradients, weight gradients, and output gradients is described, but those skilled in the art would readily understand that the statistic corresponding to the profile information may have only some of the input gradients, weight gradients, and output gradients as factors.

In operation 630, the processor may determine one or more layers to be quantized with second bit precision less than the first bit precision among the layers based on the obtained profile information. Layers with relatively low importance have a relatively small effect on the accuracy loss even if the layers are quantized with lower bit precision. Accordingly, the processor may determine layers with relatively low importance among layers included in the first neural networks as layers to be quantized with second bit precision.

For example, the processor may sort the layers in the order of the statistical size corresponding to the profile information and may determine, among the sorted layers, layers with a relatively small statistic size as one or more layers to be quantized. As described above in operation 620, the smaller the statistical size, the smaller the effect on the accuracy loss of the neural network; thus, the layers with the relatively small statistical size are determined as the layers to be quantized.

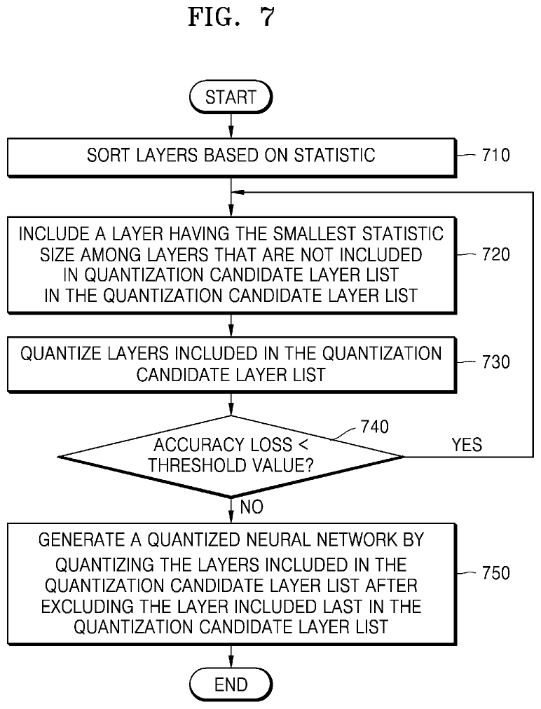

The processor may determine one or more layers to be quantized by searching whether the accuracy loss of the second neural network is within a predetermined threshold value or not compared with the first neural network when several layers of the sorted layers are quantized with the second bit precision. Here, the accuracy loss may be related to a recognition rate of the neural network. Hereinafter, a method of determining layers to be quantized will be described in more detail with reference to FIG. 7.

In operation 640, the processor quantizes the determined layers from among the layers with second-bit precision, and thus, a second neural network is generated. As described above, the processor may generate a second neural network in which the accuracy loss is minimized, and the amount of computation is greatly reduced by quantizing only the layers having relatively low importance among layers included in the first neural networks with second bit precision.

On the other hand, according to an embodiment, the first neural network may correspond to a neural network quantized from a third neural network having layers of floating-point parameters of a third bit precision greater than the first bit precision and having layers of fixed-point parameters of a first bit precision. In other words, the first neural network may correspond to a pre-quantized neural network that is generated as quantization of the third neural network is performed.

The second neural network may correspond to a quantized neural network in which layers determined from among layers included in the first neural network have fixed-point parameters of the second bit precision, and the remaining layers have fixed-point parameters of the first bit precision.

The processor may generate a second neural network by performing quantization for each channel of the determined layers of the first neural network by using the obtained profile information without retraining. The processor obtains only profile information by performing a forward pass and a backward pass of the first neural network for each of the plurality of input data sets, but may not retrain the first neural network based on the results of the forward pass and the backward pass of the first neural network. Accordingly, a quantization that may minimize the accuracy loss without requiring a memory capacity for storing computing resources, time, and a plurality of input data sets, etc. required to retrain the first neural network may be performed.

FIG. 7 is a flowchart of a method of determining layers to be quantized according to an embodiment. The method of FIG. 7 may be performed by a processor (e.g., the processor 110 of FIG. 4) of a neural network quantization apparatus (e.g., the neural network quantization apparatus 10 of FIG. 4). The method of FIG. 7 may be an example of a specific method for performing the operation 630 of FIG. 6, but the operation 630 of FIG. 6 is not limited to the method of FIG. 7.

In operation 710, the processor may sort layers based on a statistic. For example, the processor may sort the layers included in the neural network in ascending or descending order based on the statistical size corresponding to the profile information described with reference to FIG. 6.

In operation 720, the processor may include a layer having the smallest statistical size among layers that are not included in a quantization candidate layer list in the quantization candidate layer list. If operation 720 is repeated according to a result of the determination of operation 740 to be described later, layers may be sequentially added to the quantization candidate layer list one by one.

In operation 730, the processor may quantize layers included in the quantization candidate layer list. Quantizing the layers denotes converting floating-point parameters included in each of the layers to fixed-point parameters or reducing the bit precision of the parameters.

In operation 740, the processor may determine whether the accuracy loss occurred by the quantization of the neural network is less than a predetermined threshold value or not. The processor may perform operation 720 again if the accuracy loss is less than a predetermined threshold value, and perform operation 750 if the accuracy loss is greater than the predetermined threshold value.

In operation 750, the processor may generate a quantized neural network by quantizing the layers included in the quantization candidate layer list after excluding the last layer included in the quantization candidate layer list. As the layer included last in the quantization candidate layer list is excluded, the maximum number of layers may be included in the quantization candidate layer list while reducing the accuracy loss of the quantized neural network to be less than the predetermined threshold value.

In this way, the processor may detect whether the accuracy loss of the quantized neural network is within a predetermined threshold value by comparing the accuracy loss with that of a neural network before quantization, when some of the layers from among the sorted layers are quantized by sequentially including layers determined to have relatively low importance in the quantization candidate layer list.

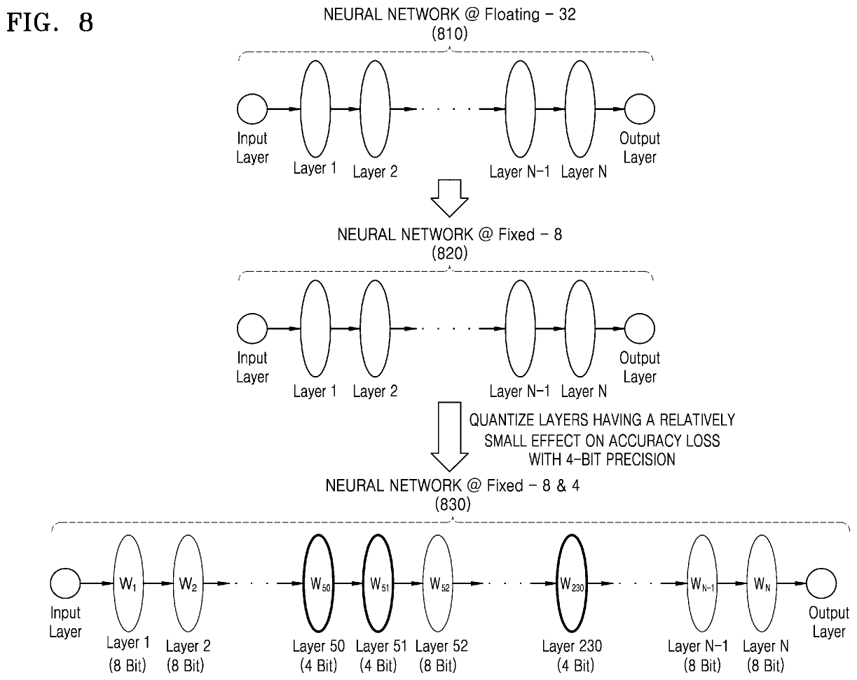

FIG. 8 is a schematic diagram illustrating a process of quantizing a neural network, according to an embodiment.

Referring to FIG. 8, a neural network 810 includes N hidden layers with 32-bit floating-point parameters. The neural network 810 may correspond to a neural network trained by using 32-bit floating-point parameters in a device capable of processing a relatively large amount of computation and memory access frequencies (for example, the device may correspond to a server or a PC, but is not limited thereto).

The neural network 810 may be quantized in consideration of processing performance of a device (for example, a mobile device, an embedded device, etc., but is not limited thereto) to which the neural network 810 is deployed. A neural network 820 may be generated as the neural network 810 is quantized.

The neural network 820 may correspond to a neural network having 8-bit fixed-point parameters, quantized from the neural network 810. In order to further increase energy efficiency and inference speed, it may be required to quantize the neural network 820 having a lower bit precision. However, if all layers included in the neural network 820 are quantized with a lower bit precision (for example, 4-bit precision), a much less accuracy may be obtained compared with the neural network 810 (for example, at a level of 20% or less of the neural network 810).

Therefore, in order to minimize the accuracy loss while further increasing the energy efficiency and the inference speed through the reduction in computation, it is desirable to quantize only some of the layers included in the neural network 820 (particularly, layers having relatively low importance).

The processor (for example, the processor 110 of FIG. 4) may analyze statistic for each layer based on the results of forward and backward passes of the neural network 820 quantized with 8-bit precision, and may determine one or more layers to be quantized with 4-bit precision less than 8-bit precision based on the analyzed statistic. Accordingly, some of the determined layers from among the entire layers of the neural network 820 may be quantized with 4-bit precision.

Finally, the neural network 820 may be quantized to a neural network 830 that includes some layers with fixed-point parameters with 4-bit precision and remaining layers with fixed-point parameters with 8-bit precision.

Meanwhile, the bit precision numbers (32 bits, 8 bits, or 4 bits) and identification numbers of the neural networks 810, 820, and 830 described with reference to FIG. 8 are merely examples for convenience of description, and the embodiments are not limited thereto. Also, in FIG. 8, although a two-stage method has been described, that is, after the first neural network 810 is quantized to the second neural network 820, the second neural network 820 is quantized to the third neural network 830, but it is not necessarily limited thereto. The quantization of the first neural network 810 may be performed in a single-stage method, that is, among the layers included in the first neural network 810, if one or more layers to be quantized with 4-bit precision are determined, the determined layers are quantized with 4-bit fixed-point precision and the remaining layers are quantized with 8-bit fixed-point precision.

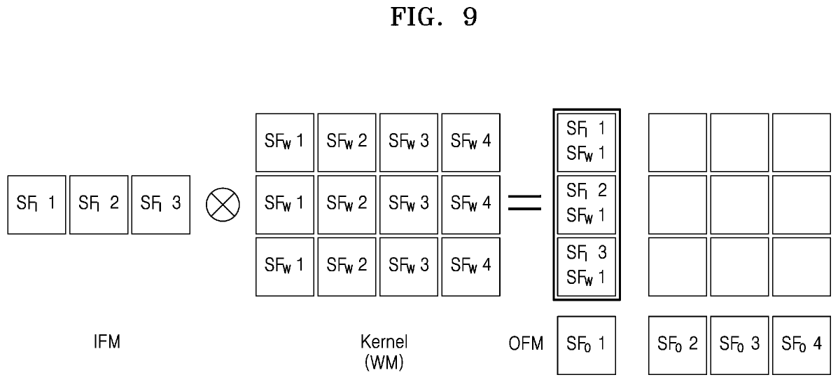

FIG. 9 is a diagram for describing a scale factor used for quantizing a neural network, according to an embodiment.

According to some embodiments, a scale factor may be used for quantizing a neural network. The scale factor may denote a coefficient multiplied by a quantized parameter or data to limit the value of the quantized parameter or data within a predetermined range. When an actual data value is R, and a value of the quantized parameter or data is x, the scale factor SF may be determined according to Equation 7 as follows.

R=SF×x+b Equation 7:

In Equation 7, b is a bias and may be a value determined for each layer or for each channel in order to match the proportional relationship between R and x. In general, the scale factor SF has a value that is very large or very small than 1, and thus, the number of bits required to express x may be much smaller than the number of bits required to express R. For example, 32-bit precision floating-point is required to express R, but only 8-bit precision fixed-point may be required to express x. Accordingly, the expression of R only in x and scale factor SF may correspond to parameter quantization.

If a quantization for applying a different scale factor for each channel is performed, after a convolution operation between the input feature map and the weight map, the number of scale factors to be considered in the process of calculating a partial sum for each channel of an output feature map may be increased by the number of channels in the input feature map. For example, as illustrated in FIG. 9, assuming that scale factors of three channels of an input feature map respectively are SF_{I}1, SF_{I}2 and SF_{I}3, and a scale factor of a weight map used to obtain the first channel of an output feature map is SF_{W}1, the scale factor SF_{O}1 of the first channel of the output feature map needs to be selected as one of SF_{I}1×SF_{W}1, SF_{I}2×SF_{W}1 and SF_{I}3×SF_{W}1.

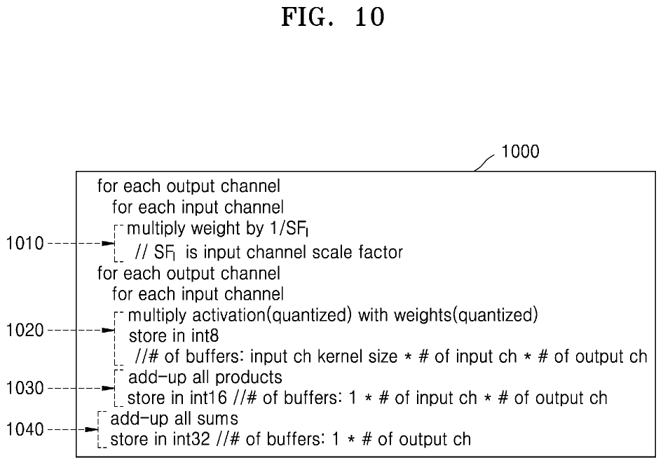

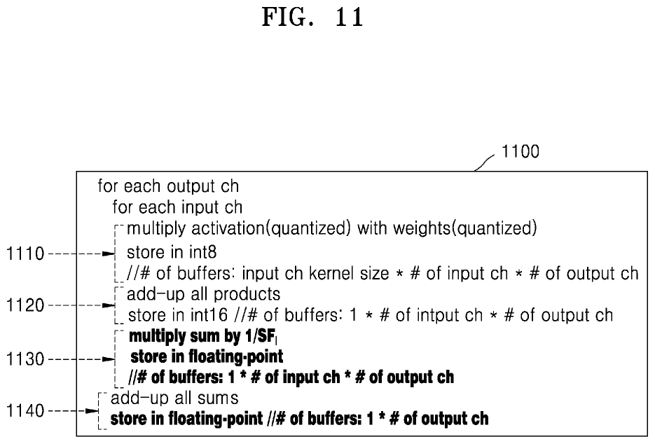

At this point, one of SF_{I}1×SF_{W}1, SF_{I}2×SF_{W}1 and SF_{I}3×SF_{W}1 is selected as the scale factor SF_{O}1, information loss may occur in the process of quantizing with the unified selected scale factor. Also, the generated information loss may increase as the difference between the scale factors of each channel of the input feature map increases. Hereinafter, in order to solve the above-described problem, which algorithm is applied to each of the related art and some embodiments of the present disclosure will be described in detail with reference to FIGS. 10 and 11.

FIG. 10 is a diagram showing an algorithm 1000 for performing inference by using a quantized neural network according to the related art.

Referring to FIG. 10, the algorithm 1000 used in the process of performing inference using a quantized neural network according to the related art is illustrated. Since parameters included in the quantized neural network are quantized with a relatively low bit precision, an input channel and output channel of each layer of the quantized neural network also need to be quantized. Meanwhile, a scale factor to be determined for quantization of an input channel may be calculated in advance through profiling by using a pseudo-code, etc.

In operation 1010, in the algorithm 1000 according to the related art, a scale factor of an input channel is pre-reflected on a weight by multiplying the weight by the reciprocal of the scale factor of the input channel (that is, by dividing the weight by the scale factor of the input channel).

In operation 1020, the algorithm 1000 may perform a multiplication operation involved in a convolution operation between quantized activations of the input channel and quantized weights and store the result with 8-bit fixed-point precision. At this point, the number of buffers required for storing the result may correspond to “the size of the input channel kernel (weight map)*the number of input channels*the number of output channels.”

In operation 1030, the algorithm 1000 may add all results of the multiplication operation according to operation 1020 as an addition operation accompanying the convolution operation and store the result with 16-bit fixed-point precision. At this point, the number of buffers required for storing the result may correspond to “the number of input channels*the number of output channels.”

In operation 1040, the algorithm 1000 may add all the results of the addition operation and store the result with 32-bit fixed-point precision. At this point, the number of buffers required for storing the result may correspond to “the number of output channels.”

In this way, the algorithm 1000 according to the related art may reduce the number of scale factors to be considered in the process of calculating the partial sum for each channel of an output feature map to a scale factor of a kernel (weight map) by pre-reflecting the scale factor of an input channel to the weight. However, according to the algorithm 1000 of the related art, as the scale factor of the input channel is pre-reflected on the weight, a range of values of the weight is changed, and thus, the resolution in quantization with lower bit precision is affected, and accordingly, accuracy is reduced.

FIG. 11 is a diagram illustrating an algorithm 1100 for performing inference by using a quantized neural network, according to an embodiment.

Referring to FIG. 11, the algorithm 1100 used in the process of performing inference using a quantized neural network, according to an embodiment is illustrated. The algorithm 1100 of FIG. 11 may be executed by a processor (e.g., the processor 110 of FIG. 4) of a neural network quantization apparatus (e.g., the neural network quantization apparatus 10 of FIG. 4). However, the present inventive concept is not limited thereto, and when the neural network quantized by the neural network quantization apparatus is transmitted to another apparatus, the algorithm 1100 may be executed by a processor of another apparatus. The algorithm 1100 may be used in an inference process using a quantized neural network (e.g., a second neural network described with reference to FIG. 6).

In operation 1110, the algorithm 1100, according to an embodiment may perform a multiplication operation accompanying a convolution operation between a quantized input feature map and a weight map by using a scale factor determined for each channel and may store the result with 8-bit fixed-point precision. At this point, the number of buffers required for storing the result may correspond to “the size of the input channel kernel (weight map)*the number of input channels*the number of output channels.”

In operation 1120, the algorithm 1100 is an addition operation accompanying a convolution operation, which may add all the results of the multiplication operation according to operation 1110 and store the result with 16-bit fixed-point precision. At this point, the number of buffers required for storing the result may correspond to “the number of input channels*the number of output channels.”

In operation 1130, the algorithm 1100 may multiply the result of the addition operation by the reciprocal of the scale factor of the input channel. In other words, before calculating a partial sum for each channel of the output feature map, the algorithm 1100 may reflect the scale factor of the input feature map in the results of the convolution operation. Also, the algorithm 1100 may store the result on which the scale factor is reflected with floating-point precision. At this point, the number of buffers required for storing the result may correspond to “the number of input channels*the number of output channels.” The scale factor of the input channel may be calculated in advance through profiling using similar codes.

In operation 1140, the algorithm 1100 may obtain an output feature map by accumulating the convolution operation results on which the scale factor of the input feature map for each channel is reflected. Also, the algorithm 1100 may store the output feature map with floating-point precision. At this time, the number of buffers required for storing the result may correspond to “the number of output channels.”

In this way, according to an embodiment, since the scale factor of the input feature map is reflected on the results of the convolution operation before calculating the partial sum for each channel of the output feature map, weight values are expressed as original values, and thus, the reduction of accuracy may be prevented. Also, since the output feature map may be quantized by using the scale factor of the weight map without determining a separate scale factor for the output feature map, information loss occurred in the process of determining the scale factor of the output feature map may be prevented.

Also, according to an embodiment, in an inference process, a shift operation in which the result of a multiplication operation is divided by a scale factor of each input channel is required. However, the shift operation is faster than an operation for determining a scale factor of an output feature map. Also, a fixed-point precision buffer of “number of input channels*number of output channels” is additionally required, but, the shift operation may be considered as having a reasonable cost in view of the degree of preventing accuracy loss.

The bit precision numbers (32 bits, 16 bits, or 8 bits) and parameter types (floating-point or fixed-point) of the neural network described in FIG. 11 are only examples for convenience of explanation, and the embodiments are limited thereto.

The embodiments of the inventive concept may be implemented as a computer-readable program, and may be realized in general computers that execute the program by using computer-readable recording media. Also, the structure of data used in the embodiments of the inventive concept may be recorded on a computer-readable recording medium through various means. The computer-readable medium may be magnetic storage media (e.g., ROM, floppy disks, hard disks, etc.) and optical recording media (e.g., CD-ROMs or DVDs), and transmission media such as Internet transmission media.

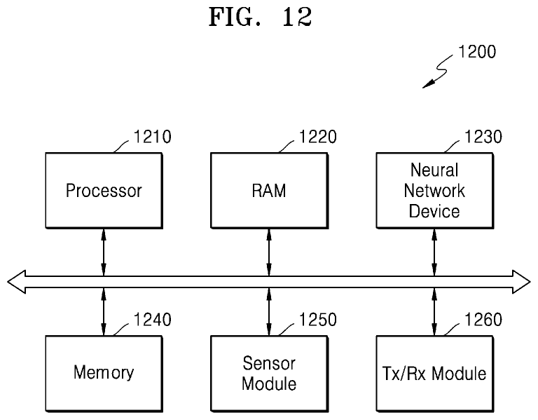

FIG. 12 is a block diagram illustrating a configuration of an electronic system, according to an embodiment.

Referring to FIG. 12, the electronic system 1200 may extract valid information by analyzing input data in real-time based on a neural network and determine a situation or control the configuration of a device on which the electronic system 1200 is mounted based on the extracted information. For example, the electronic system 1200 may be applied to a robotic device, such as a drone or an advanced driver assistance system (ADAS), a smart TV, a smart phone, a medical device, a mobile device, an image display device, a measurement device, an IoT device and may be mounted on at least one of various types of electronic devices.

The electronic system 1200 may include a processor 1210, a RAM 1220, a neural network device 1230, a memory 1240, a sensor module 1250, and a communication module 1260. The electronic system 1200 may further include an input/output module, a security module, and a power control device. Some of the hardware components of the electronic system 1200 may be mounted on at least one semiconductor chip.

The processor 1210 controls an overall operation of the electronic system 1200. The processor 1210 may include a single processor core (Single Core), or a plurality of processor cores (Multi-Core). The processor 1210 may process or execute programs and/or data stored in the memory 1240. In some embodiments, the processor 1210 may control functions of the neural network device 1230 by executing programs stored in the memory 1240. The processor 1210 may be implemented by a CPU, GPU, AP, etc.

The RAM 1220 may temporarily store programs, data, or instructions. For example, programs and/or data stored in the memory 1240 may be temporarily stored in the RAM 1220 according to the control or booting code of the processor 1210. The RAM 1220 may be implemented as a memory, such as dynamic RAM (DRAM) or static RAM (SRAM).

The neural network device 1230 may perform an operation of the neural network based on received input data and generate an information signal based on the execution result. Neural networks may include convolution neural networks (CNN), recurrent neural networks (RNN), deep belief networks, restricted Boltzmann machines, etc., but are not limited thereto. The neural network device 1230 may have various processing functions, such as generating a neural network, learning or training a neural network, quantizing a neural network having floating-point parameters to a neural network having fixed-point parameters, or retraining the neural network. In one example, the neural network device 1230 may be the neural network quantization apparatus 10 of FIG. 4 described above and may also correspond to a hardware accelerator dedicated to a neural network or a device including the same as hardware that performs processing by using a quantized neural network.

The information signal may include one of the various types of recognition signals, such as a voice recognition signal, an object recognition signal, an image recognition signal, and a biometric information recognition signal. For example, the neural network device 1230 may receive frame data included in a video stream as input data and generate, on the basis of the frame data, a recognition signal with respect to an object included in an image displayed by the frame data. However, the present inventive concept is not limited thereto, and the neural network device 1230 may receive various types of input data according to the type or function of an electronic device on which the electronic system 1200 is mounted and generate a recognition signal according to the input data.

The memory 1240 is a storage for storing data and may store an operating system (OS), various programs, and various data. In an embodiment, the memory 1240 may store intermediate results generated in the process of performing an operation of the neural network device 1230, for example, an output feature map may be stored in the form of an output feature list or an output feature matrix. In an embodiment, a compressed output feature map may be stored in the memory 1240. Also, the memory 1240 may store quantized neural network data, for example, parameters, a weight map, or a weight list used in the neural network device 1230.

The memory 1240 may be DRAM, but is not limited thereto. The memory 1240 may include at least one of volatile memory and non-volatile memory. The non-volatile memory includes ROM, PROM, EPROM, EEPROM, flash memory, PRAM, MRAM, RRAM, FRAM, etc. The volatile memory includes DRAM, SRAM, SDRAM, PRAM, MRAM, RRAM, FeRAM, etc. In an embodiment, the memory 1240 may include at least one of HDD, SSD, CF, SD, Micro-SD, Mini-SD, xD, and Memory Stick.

The sensor module 1250 may collect information around an electronic device on which the electronic system 1200 is mounted. The sensor module 1250 may sense or receive a signal (e.g., an image signal, a voice signal, a magnetic signal, a biosignal, a touch signal, etc.) from the outside of the electronic device and convert the sensed or received signal into data. To this end, the sensor module 1250 may include at least one of various types of sensing devices, for example, a microphone, an imaging device, an image sensor, light detection and ranging (LiDAR) sensor, an ultrasonic sensor, an infrared sensor, a biosensor, and a touch sensor.

The sensor module 1250 may provide converted data as input data to the neural network device 1230. For example, the sensor module 1250 may include an image sensor, generate a video stream by photographing an external environment of the electronic device, and sequentially provide successive data frames of the video stream to the neural network device 1230 as input data. However, the present disclosure is not limited thereto, and the sensor module 1250 may provide various types of data to the neural network device 1230.

The communication module 1260 may include various wired or wireless interfaces capable of communicating with external devices. For example, the communication module 1260 may include a local area network (LAN), a wireless local area network (WLAN), such as Wi-Fi, a wireless personal area network (WPAN), such as Bluetooth, a wireless universal serial bus (USB), ZigBee, near-field communication (NFC), radio-frequency identification (RFID), power-line communication (PLC), or a communication interface capable of connecting to a mobile cellular network, such as 3rd generation (3G), 4th generation (4G), or long-term evolution (LTE).

In an embodiment, the communication module 1260 may receive data regarding a pre-trained neural network or quantized neural network from an external device. The neural network device 1230 may perform inference by using a neural network received from an external device as it is, or perform quantization on the neural network received from the external device. For example, the neural network device 1230 may quantize at least some of layers from among layers included in the neural network received from an external device with lower bit precision. Data of the quantized neural network may be stored in the memory 1240.

The neural network quantization apparatus 10, processor 110, memory 120 in FIGS. 1-9 and 11-12 that perform the operations described in this application are implemented by hardware components configured to perform the operations described in this application that are performed by the hardware components. Examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. A hardware component may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 1-9 and 11-12 that perform the operations described in this application are performed by computing hardware, for example, by one or more processors or computers, implemented as described above executing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions in the specification, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media. Examples of a non-transitory computer-readable storage medium include read-only memory (ROM), random-access memory (RAM), flash memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, magnetic tapes, floppy disks, magneto-optical data storage devices, optical data storage devices, hard disks, solid-state disks, and any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A method for neural network quantization, comprising:
performing a forward pass and a backward pass of a first neural network having a first bit precision with respect to each of a plurality of input data sets;
obtaining profile information with respect to at least one of input gradients, weight gradients, and output gradients calculated for each layer of layers included in the first neural network in the process of performing the backward pass;
determining one or more layers, from among the layers, to be quantized with a second bit precision less than the first bit precision, based on the obtained profile information; and
generating a second neural network by quantizing the determined layers from among the layers with the second bit precision.

2. The method of claim 1, wherein the profile information includes a normalized statistic obtained by dividing an average of absolute values of the weight gradients by an average of absolute values of weights.

3. The method of claim 1, wherein the profile information includes a normalized statistic obtained based on values of the weight gradients and weight values.

4. The method of claim 1, wherein the profile information includes a statistic obtained by dividing a variance of absolute values of the input gradients by an average of the absolute values of the input gradients.

5. The method of claim 1, wherein the profile information includes a normalized statistic obtained based on variance values of the input gradients and the input gradient values.

6. The method of claim 1, wherein the profile information includes a normalized statistic obtained by dividing a variance of absolute values of weights for each of the layers by a number of parameters for each channel.

7. The method of claim 1, wherein the profile information includes a normalized statistic obtained based on values of weights and a number of parameters for each of the layers.

8. The method of claim 1, further comprising sorting the layers in an order of statistical size corresponding to the obtained profile information, wherein
the determining of the layers comprises determining layers having a relatively small statistical size as one or more layers to be quantized from among the sorted layers.

9. The method of claim 8, wherein the determining of the layers comprises determining one or more layers to be quantized by searching whether an accuracy loss of the second neural network is within a predetermined threshold value compared with the first neural network when some of the sorted layers are quantized with the second bit precision.

10. The method of claim 1, wherein the first neural network corresponds to a neural network quantized from a third neural network having layers of floating-point parameters of a third bit precision that is greater than the first bit precision and having layers of fixed-point parameters of the first bit precision, and
the second neural network corresponds to a neural network quantized such that the determined layers from among the layers have fixed-point parameters with the second bit precision and the remaining layers have fixed-point parameters with the first bit precision.

11. The method of claim 1, wherein the method generates the second neural network by performing quantization for each channel of the determined layers of the first neural network based on the obtained profile information without retraining the second neural network.

12. The method of claim 1, further comprising:
performing a convolution operation between a quantized input feature map and a weight map based on a scale factor determined for each channel in an inference process using the generated second neural network;
reflecting the scale factor of the input feature map on the results of the convolution operation before calculating the partial sum for each channel of a output feature map; and
obtaining the output feature map by accumulating the results of the convolution operation on which the scale factor of the input feature map is reflected for each channel.

13. The method of claim 12, further comprising quantizing the output feature map based on the scale factor of the weight map without determining a separate scale factor for the output feature map.

14. A neural network quantization apparatus comprising:
a memory storing at least one program; and
a processor configured to perform neural network quantization by executing the at least one program, wherein
the processor is further configured to perform, with respect to each of a plurality of input data sets, a forward pass and a backward pass of a first neural network having a first bit precision,
obtain profile information for at least one of input gradients, weight gradients, and output gradients calculated for each layer of layers included in the first neural network in the process of performing the backward pass,
determine one or more layers to be quantized with a second bit precision less than the first bit precision, among the layers, based on the obtained profile information, and
generate a second neural network by quantizing the determined layers from among the layers with the second bit precision.

15. The neural network quantization apparatus of claim 14, wherein the profile information includes a normalized statistic by dividing an average of absolute values of the weight gradients by an average of absolute values of weights.

16. The neural network quantization apparatus of claim 14, wherein the profile information includes a statistic obtained by dividing a variance of absolute values of the input gradients by an average of the absolute values of the input gradients.

17. The neural network quantization apparatus of claim 14, wherein the profile information includes a normalized statistic obtained by dividing a variance of absolute values of weights for each layer of the layers by a number of parameters for each channel.

18. The neural network quantization apparatus of claim 14, wherein the processor is further configured to sort the layers in an order of statistical size corresponding to the obtained profile information, and
determine layers having a relatively small statistical size as one or more layers to be quantized, from among the sorted layers.

19. The neural network quantization apparatus of claim 14, wherein the processor is further configured to determine one or more layers to be quantized by searching whether an accuracy loss of the second neural network is within a predetermined threshold value compared with the first neural network when some of the sorted layers are quantized with the second bit precision.

20. The neural network quantization apparatus of claim 14, wherein the first neural network corresponds to a neural network quantized from a third neural network having layers of floating-point parameters of a third bit precision that is greater than the first bit precision and having layers of fixed-point parameters of the first bit precision, and
the second neural network corresponds to a neural network quantized such that the determined layers from among the layers have fixed-point parameters with the second bit precision and the remaining layers have fixed-point parameters with the first bit precision.

21. The neural network quantization apparatus of claim 14, wherein the processor is further configured to generate the second neural network is by performing quantization for each channel of the determined layers of the first neural network based on the obtained profile information without retraining the second neural network.

22. The neural network quantization apparatus of claim 14, wherein the processor is further configured to:
perform a convolution operation between a quantized input feature map and a weight map based on a scale factor determined for each channel in an inference process using the generated second neural network;
reflect the scale factor of the input feature map to the results of the convolution operation before calculating the partial sum for each channel of a output feature map; and
obtain the output feature map by accumulating the results of the convolution operation on which the scale factor of the input feature map is reflected for each channel.

23. The neural network quantization apparatus of claim 14, wherein the processor is further configured to quantize the output feature map based on the scale factor of the weight map without determining a separate scale factor for the output feature map.

24. The neural network quantization apparatus of claim 14, wherein a configuration of an electronic system is controlled or determined based on the neural network quantization apparatus.
